(19) United States
(12) Patent Application Publication
(10) Pub. No.: US 2022/0032726 A1
(43) Pub. Date: Feb. 3, 2022

(54) HEAT EXCHANGER COOLING DEVICE

(71) Applicant: TOYOTA JIDOSHA KABUSHIKI KAISHA, Aichi-ken (JP)

(72) Inventor: Takaki Nakagawa, Toyota-shi (JP)

(21) Appl. No.: 17/347,591

(22) Filed: Jun. 15, 2021

(30) Foreign Application Priority Data
Jul. 30, 2020 (JP) 2020-129446

(51) Int. Cl. B60H 1/00; B05B 15/522; H01M 8/04014; H01M 8/04029; H01M 8/04044; H01M 8/04007

(52) U.S. Cl. CPC B60H 1/00278; B05B 15/5225; H01M 8/04014; B60H 2001/00307; H01M 8/04044; H01M 8/04059; B60H 2001/003; H01M 8/04029

(57) ABSTRACT

An emission part of a cooling device has a plurality of emission holes. In the emission part, a separator urged by coil springs is disposed, and needles respectively corresponding to the emission holes are provided on the separator. As the separator is moved to a closing position, leading end portions of the needles are inserted into the emission holes to close the emission holes. Thus, when emission of water through the emission holes is stopped in the emission part, water inside the emission holes is pushed out and removed by the leading end portions of the needles inserted into the emission holes. This can reduce the likelihood of clogging of the emission holes due to water that cools a radiator by its latent heat of evaporation.

### CROSS-REFERENCE TO RELATED APPLICATION

This application claims priority to Japanese Patent Application No. 2020-129446 filed on Jul. 30, 2020, incorporated herein by reference in its entirety.

### BACKGROUND

### 1. Technical Field

The disclosure relates to a heat exchanger cooling device that is provided in a vehicle.

### 2. Description of Related Art

In a vehicle, a refrigerant is circulated between a radiator as a heat exchanger and a fuel cell as an object-to-be-cooled, and the refrigerant is cooled by the radiator to thereby cool the fuel cell. In this case, using the latent heat of evaporation of a liquid, such as water, that is sprinkled onto a front surface of the radiator can enhance the refrigerant cooling performance of the heat exchanger.

Meanwhile, the liquid remains adhering inside a nozzle hole of the nozzle having sprinkled the liquid, and as this liquid (moisture in the liquid) remaining inside the nozzle hole evaporates, the components of the liquid are precipitated inside the nozzle hole as a deposit. If grit, dust, etc. in the air adhere to the liquid remaining inside the nozzle hole, a deposit of grit, dust, etc. is precipitated inside the nozzle hole as the liquid evaporates. When the precipitated deposit builds up, it clogs the nozzle hole.

In this connection, Japanese Unexamined Patent Application Publication No. 2019-122985 discloses a nozzle clogging detection device that detects nozzle clogging of spray nozzles that spray a refrigerant. Focusing on a correlation existing between vibration of a nozzle and the degree of clogging of the nozzle, this nozzle clogging detection device compares a measured value of vibration measured by a vibration sensor installed on a nozzle and a threshold value, and determines that the nozzle is clogged when the measured value reaches the threshold value.

### SUMMARY

As clogging of a nozzle hole necessitates maintenance of the device for eliminating the clogging of the nozzle hole, it is desired to be able to reduce the likelihood of clogging of a nozzle hole.

The disclosure has been contrived in view of this fact, and an object thereof is to provide a heat exchanger cooling device that can reduce the likelihood of clogging of an ejection hole due to a liquid that cools a heat exchanger by its latent heat of evaporation.

To achieve this object, a heat exchanger cooling device according to the disclosure includes: a heat exchanger in which a refrigerant for cooling an object-to-be-cooled is cooled by exchanging heat with air introduced into the heat exchanger; an ejection part that has a hollow inside into which a liquid that cools the heat exchanger by its latent heat of evaporation is supplied by a supply part, and that has an ejection hole for ejecting the supplied liquid formed in a surface facing the heat exchanger so as to extend through the surface; a closing member that is movable between a closing position in which the closing member is inserted into the ejection hole to close the ejection hole, and a non-closing position in which the closing member has receded from the ejection hole to allow the liquid to be ejected through the ejection hole; and a moving part that moves the closing member to the non-closing position when the liquid is supplied to the ejection part, and moves the closing member to the closing position when supply of the liquid to the ejection part is stopped.

In the heat exchanger cooling device of the disclosure, the refrigerant circulated between the heat exchanger and the object-to-be-cooled is cooled in the heat exchanger by exchanging heat with air introduced into the heat exchanger, and thereby the object-to-be-cooled is cooled. The liquid that cools the heat exchanger by its latent heat of evaporation is supplied to the hollow inside of the ejection part by the supply part. The ejection part has the ejection hole formed in the surface facing the heat exchanger so as to extend through the surface, and the liquid supplied to the ejection part is ejected toward the heat exchanger through the ejection hole.

Here, the ejection part is provided with the closing member, and the closing member is movable between the closing position in which the closing member is inserted into the ejection hole to close the ejection hole and the non-closing position in which the closing member has receded from the ejection hole to allow the liquid to be ejected. The moving part moves the closing member to the non-closing position when the liquid is supplied to the ejection part, and moves the closing member to the closing position when supply of the liquid to the ejection part is stopped.

Thus, when the liquid is supplied to the ejection part by the supply part, the liquid is ejected toward the heat exchanger through the ejection hole of the ejection part, which enhances the object-to-be-cooled cooling performance of the heat exchanger. When supply of the liquid to the ejection part is stopped, the closing member is inserted into the ejection hole to close the ejection hole, so that the liquid remaining inside the ejection hole can be discharged to reduce the likelihood of clogging of the ejection hole due to the liquid remaining in the ejection hole.

As has been described above, the disclosure has the advantage of being able to reduce the likelihood of clogging of the ejection hole due to a liquid remaining inside the ejection hole by inserting the closing member into the ejection hole and discharging the liquid remaining inside the ejection hole when closing the ejection hole by the closing member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a fuel cell system according to an embodiment, as seen from a vehicle lateral side;

FIG. 2 is a sectional view showing a schematic configuration of an emission part shown in FIG. 1;

FIG. 3A is a schematic sectional view of the emission part, showing a state where emission holes are closed; and

FIG. 3B is a schematic sectional view of the emission part, showing a state where the emission holes are not closed.

### DETAILED DESCRIPTION OF EMBODIMENTS

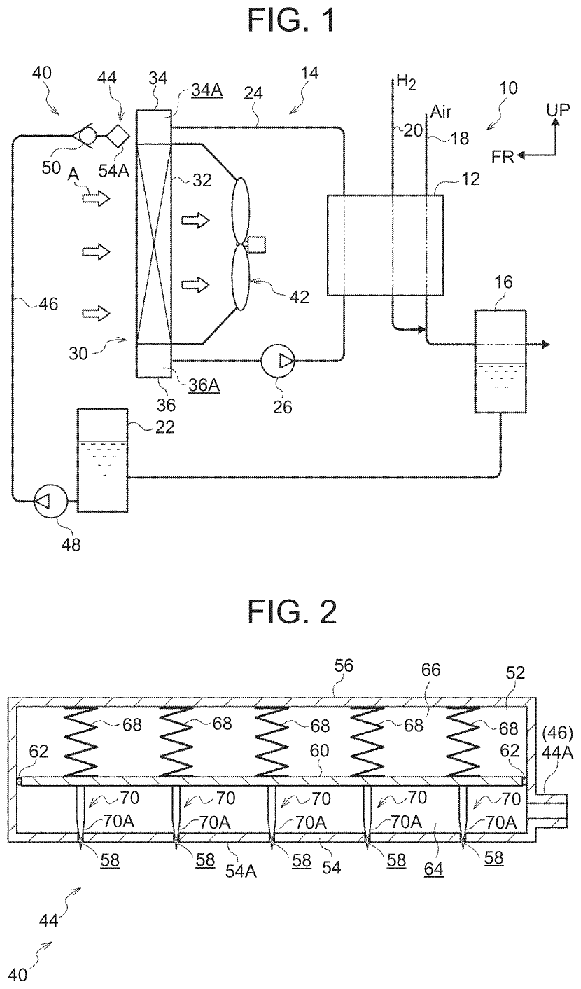

An embodiment of the disclosure will be described in detail below with reference to the drawings. This embodiment will be described using a fuel cell system 10 of a vehicle (not shown) as an example. FIG. 1 is a schematic configuration diagram of the fuel cell system 10 according to the embodiment, as seen from a vehicle lateral side. In FIG. 1, a vehicle front side is indicated by arrow FR and a vehicle upper side is indicated by arrow UP.

The vehicle equipped with the fuel cell system 10 is an electric vehicle (EV) capable of traveling on electricity. In this vehicle, electricity output from the fuel cell system 10 (including electricity that is output from the fuel cell system 10 and stored in an electricity storage part) is supplied to an electric motor (not shown) as a travel driving source.

As shown in FIG. 1, the fuel cell system 10 includes a fuel cell 12 in which a fuel cell stack (not shown) is disposed, a coolant circuit 14, and a gas-liquid separator 16 as a condenser. The fuel cell 12 of the fuel cell system 10 is supplied with air including oxygen (oxidant) through an air passage (air pipeline) 18 and supplied with hydrogen (Hz: fuel gas) through a hydrogen passage (hydrogen pipeline) 20.

The fuel cell stack of the fuel cell 12 includes a plurality of cells. In the fuel cell 12 (fuel cell stack), an electrolyte membrane is disposed between a positive electrode (an anode: a fuel electrode) of the cell and a negative electrode (a cathode: an air electrode) of the cell. In the fuel cell 12, an electrochemical reaction occurs as the hydrogen as the fuel gas flows between the positive electrode of the cell and a separator on the positive electrode side while the air including oxygen as the oxidant flows between the negative electrode of the cell and a separator on the negative electrode side. As a result, in the fuel cell 12, electric energy is generated (power generation) and the generated electric energy is output as electricity.

Further, in the fuel cell 12, reaction-product water (high-purity water) is produced by the electrochemical reaction. In the fuel cell 12, vapor of the reaction-product water (water vapor) is discharged to the gas-liquid separator 16 along with exhaust hydrogen of the unreacted fuel gas (hydrogen) that has not been used for the electrochemical reaction and exhaust gas of the oxidant (oxygen).

The gas-liquid separator 16 collects the exhaust gas and the exhaust hydrogen discharged from the fuel cell 12, and condenses the reaction-product water (water vapor) produced in the fuel cell 12 to separate it into water vapor (gas) and water. In the fuel cell system 10, the water which has been recovered by being condensed in the gas-liquid separator 16 and of which the temperature is thereby reduced is stored in a water tank 22.

In the fuel cell 12, heat is produced along with moisture (reaction-product water) by the electrochemical reaction during power generation. When the power generation efficiency is taken into account, the temperature of the fuel cell 12 needs to be maintained within a predetermined allowable range. For this reason, the fuel cell system 10 has the coolant circuit 14 that maintains the temperature of the fuel cell 12 within the predetermined allowable range.

In the coolant circuit 14, a cooling liquid such as a coolant (hereinafter referred to as a coolant) is used as a refrigerant (cooling medium), and the coolant circuit 14 includes a coolant circulation passage 24 and an electrically operated water pump (coolant pump) 26. The coolant circulation passage 24 connects a radiator 30 as a heat exchanger and heat radiator, the fuel cell 12 as an object-to-be-cooled, and the water pump 26 to one another so as to allow the coolant to circulate among these parts.

In the coolant circulation passage 24, the water pump 26 is operated to pump the coolant, and thus the coolant is circulated between the fuel cell 12 and the radiator 30. As the coolant circulated between the fuel cell 12 and the radiator 30 passes through the inside of the fuel cell 12, heat exchange is performed between the fuel cell 12 and the coolant and the fuel cell 12 can be thereby cooled.

The radiator 30 is disposed at a vehicle front part, with a height direction thereof lying in a vehicle-height direction. The radiator 30 is provided with a radiator core 32, and the radiator core 32 has a header 34 mounted at an upper end and a footer 36 mounted at a lower end. An upper tank 34A is formed in the header 34 and a lower tank 36A is formed in the footer 36, and each of the upper tank 34A of the header 34 and the lower tank 36A of the footer 36 extends in a vehicle width direction (a width direction of the radiator core 32).

A plurality of radiator tubes (not shown) is disposed in the radiator core 32, and a plurality of fins (not shown) is mounted thereon. The upper tank 34A and the lower tank 36A communicate with each other through these radiator tubes, and surface areas of the radiator tubes are increased by these fins.

In the radiator 30, the coolant having passed through the fuel cell 12 is supplied to the upper tank 34A, and this coolant flows from the upper tank 34A toward the lower tank 36A through the radiator tubes and returns from the lower tank 36A to the fuel cell 12. In the radiator 30, as an introduced wind formed by air introduced from a vehicle front side (air flowing in the direction of arrows A) passes through the radiator core 32, heat exchange is performed between this introduced wind and the coolant passing through the radiator tubes and the coolant is thereby cooled. As a result, the fuel cell 12 is cooled by the coolant circulated between the fuel cell 12 and the radiator 30.

In the coolant circuit 14, a cooling device 40 as a heat exchanger cooling device is provided. The cooling device 40 includes an electrically operated cooling fan 42. The cooling fan 42 is mounted on a vehicle rear side of the radiator 30, and when the cooling fan 42 is operated, the volume of the introduced wind (travel wind) introduced into the radiator 30 increases and thus the coolant cooling performance of the radiator 30 is enhanced.

In the cooling device 40, an emission part 44 as an ejection part, a water supply passage 46, an electrically operated water supply pump 48 as a water supply part, and a check valve 50 are disposed. In the cooling device 40, the water stored in the water tank 22 is used as a liquid that cools the radiator 30 by its latent heat of evaporation. The water supply passage 46 is coupled at one end to the emission part 44 and at the other end to the water tank 22, and the water supply passage 46 provides communication between the water tank 22 and the emission part 44. In the water supply passage 46, the water supply pump 48 is disposed between the water tank 22 and the emission part 44, and the check valve 50 is disposed between the emission part 44 and the water supply pump 48.

In the cooling device 40, the operation of the cooling fan 42 and the water supply pump 48 as well as the operation of the water pump 26 is controlled by a control unit (not shown). In the cooling device 40, as the water supply pump 48 is operated, the water (reaction-product water) stored in the water tank 22 is supplied to the emission part 44. The check valve 50 prevents the water supplied to the emission part 44 from flowing toward the water supply pump 48 (water tank 22).

FIG. 2 is a sectional view of a section of the emission part 44 along the vehicle width direction that is a width direction of the radiator 30 (radiator core 32), showing a schematic configuration of the emission part 44. While this embodiment will be described with one emission part 44 shown as an example, a plurality of emission parts 44 may be disposed in the cooling device 40, on the vehicle front side of the radiator 30.

As shown in FIG. 2, the emission part 44 has an elongated, substantially rectangular box shape (substantially rectangular tubular shape) formed by a pair of side walls 52 (one of which is shown in FIG. 2) each having a band plate shape, a front wall 54, and a rear wall 56 facing the front wall 54. The emission part 44 is disposed at an upper part of the radiator 30, on the vehicle front side of the radiator 30 (radiator core 32), with a longitudinal direction thereof lying in the vehicle width direction.

One end side of the emission part 44 in the longitudinal direction is closed, and an inlet 44A is mounted at the other end in the longitudinal direction. The water supply passage 46 (see FIG. 1) is connected to the inlet 44A. Thus, water is supplied to the hollow inside of the emission part 44 through the water supply passage 46.

The emission part 44 has a plurality of emission holes 58 formed in the front wall 54 as ejection holes. The emission holes 58 are disposed at positions at predetermined intervals along the longitudinal direction of the emission part 44 and formed in a circular shape so as to extend through the front wall 54, and each of the emission holes 58 opens on an outer surface side of the front wall 54. (This surface will be referred to as an emission surface 54A.)

The emission surface 54A of the emission part 44 is directed toward the radiator 30 (radiator core 32) (see FIG. 1). Thus, the emission part 44 has openings so as to be able to eject the water supplied from the water tank 22 by emitting (or spraying or jetting) the water toward a surface of the radiator core 32 (radiator 30) on the vehicle front side through each of the emission holes 58. In the cooling device 40, the number of the emission holes 58 formed in the emission part 44, the intervals and the opening diameter of the emission holes 58, etc., as well as the position of arrangement of the emission part 44 (when there is a plurality of emission parts 44, the positions of arrangement of the respective emission parts 44), the pressure of water supplied to the emission part 44, etc., are determined such that water can be caused to adhere to the surface of the radiator core 32 on the vehicle front side at substantially equal intervals in an height direction and a width direction.

A separator 60 constituting a moving part is disposed inside the emission part 44. The separator 60 has a band plate shape corresponding to the shape of an inner surface of the emission part 44, and is disposed substantially parallel to each of the front wall 54 and the rear wall 56 with a longitudinal direction thereof lying in the longitudinal direction of the emission part 44.

A seal member 62 is disposed on end surfaces at outer peripheral edges of the separator 60, and the seal member 62 is attached around the entire separator 60. The separator 60 is disposed closer to the rear wall 56 than the inlet 44A is, and the seal member 62 around the entire separator 60 is in close contact with inner surfaces of the emission part 44. The seal member 62 can slide over the inner surfaces of the emission part 44 (inner surfaces at both ends in the longitudinal direction and inner surfaces of the pair of side walls 52).

Thus, an internal space of the emission part 44 is divided by the separator 60 into a front chamber 64 on the side of the front wall 54 and a rear chamber 66 on the side of the rear wall 56, and the inlet 44A and each of the emission holes 58 open to the front chamber 64. The separator 60 can be moved inside the emission part 44, parallel to the front wall 54 (and the rear wall 56) in directions toward and away from these walls, and the volumes of the front chamber 64 and the rear chamber 66 change as the separator 60 is moved.

The emission part 44 is provided with a plurality of coil springs (helical compression springs) 68 as an urging part that constitutes a moving part. The coil springs 68 are interposed between the rear wall 56 and the separator 60 and, as one unit, urge the separator 60 toward the front wall 54. Thus, the separator 60 is moved inside the emission part 44 toward the front wall 54 by the urging force of the coil springs 68. When pushed toward the rear wall 56 with a predetermined pressure, the separator 60 is moved inside the emission part 44 toward the rear wall 56 against the urging force of the coil springs 68.

A plurality of needles 70 as closing members is disposed inside the emission part 44. The needles 70 have a rod shape with a circular cross-section. The needles 70 are disposed inside the front chamber 64, with their respective axes aligned with central axes of the respective emission holes 58, and are fixed at one end side (base end side) in a longitudinal direction on the separator 60. Thus, the needles 70 are movable inside the emission part 44 integrally with the separator 60.

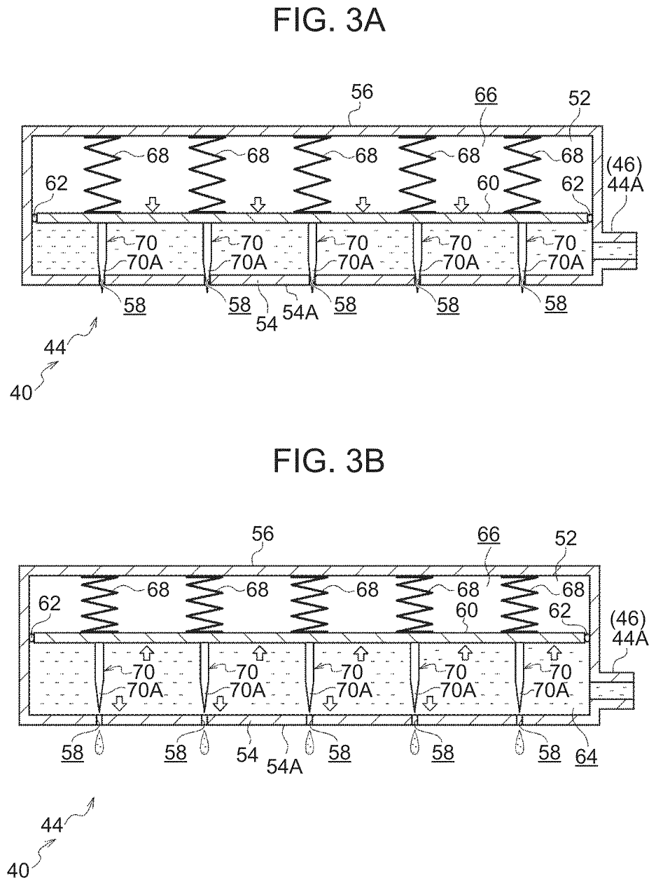

FIG. 3A and FIG. 3B are sectional views showing a section of the emission part 44 along the longitudinal direction. FIG. 3A shows a state where the separator 60 has been moved toward the rear wall 56 (the opposite side from the front wall 54), and FIG. 3B shows a state where the separator 60 has been moved toward the front wall 54.

The outside diameter of the needle 70 at the base end side is larger (wider) than the opening diameter of the emission hole 58, and a portion of the needle 70 at the other end in the longitudinal direction (leading end portion 70A) has a conical shape. The diameter of the leading end portion 70A of the needle 70 decreases toward a tip thereof. The leading end portion 70A of the needle 70 can be inserted into the emission hole 58 up to a point where the outside diameter of the leading end portion 70A becomes equal to the inside diameter of the emission hole 58.

As such, the needles 70 close the emission holes 58 by the leading end portions 70A as shown in FIG. 3A, as the leading end portions are inserted up to a position at which the outside diameter thereof becomes equal to the inside diameter of the emission holes 58. When the leading end portions 70A are inserted up to a position at which the emission holes 58 are closed, movement of the separator 60 toward the front wall 54 along with the needles 70 is restricted. In the emission part 44, the position at which the leading end portions 70A of the needles 70 are inserted into the emission holes 58 and the movement of the separator 60 toward the front wall 54 is restricted is set as a closing position.

In the emission part 44, the leading end portions 70A of the needles 70 are pulled out of the emission holes 58 as the separator 60 is moved toward the rear wall 56. As shown in FIG. 3B, a non-closing position for the emission holes 58 is set in the emission part 44. A stopper (not shown) is provided on an inner surface of the emission part 44, and the movement of the separator 60 toward the rear wall 56 is restricted by this stopper.

The non-closing position is a position at which the separator 60 has been moved toward the rear wall 56 against the urging force of the coil springs 68. In the non-closing position, the leading end portions 70A of the needles 70 are pulled out and released from the emission holes 58, and water is emitted through the emission holes 58.

In the cooling device 40, when the water supply pump 48 is operated to supply water into the front chamber 64 of the emission part 44 and thereby the water pressure inside the front chamber 64 rises, the water inside the front chamber 64 pushes the separator 60. Thus, in the emission part 44, the separator 60 is moved to the non-closing position by the water pressure against the urging force of the coil springs 68 (see FIG. 3B), and each of the emission holes 58 is opened and the water inside the front chamber 64 is emitted through the emission holes 58.

In the cooling device 40, the water pressure inside the front chamber 64 decreases when the water supply pump 48 is stopped. Thus, in the emission part 44, the separator 60 is moved toward the front wall 54 by the urging force of the coil springs 68, and the leading end portions 70A of the needles 70 are respectively inserted into the emission holes 58, so that the emission holes 58 are closed by the leading end portions 70A of the needles 70 and movement of the separator 60 is restricted (see FIG. 3A).

Next, the workings and effects of the embodiment will be described.

In the fuel cell system 10, a fuel gas (hydrogen) and air including an oxidant (oxygen) are supplied to the fuel cell 12, so that an electrochemical reaction occurs inside the fuel cell 12 and electric energy is generated along with moisture (water vapor) and heat. In the fuel cell system 10, electricity corresponding to the generated electric energy is output from the fuel cell 12 as electricity for traveling. Further, in the fuel cell system 10, exhaust hydrogen and exhaust gas are discharged from the fuel cell 12 to the gas-liquid separator 16, and water is recovered in the gas-liquid separator 16 and stored in the water tank 22.

The cooling device 40 operates the water pump 26 and the cooling fan 42 according to power generation in the fuel cell 12, and cools the coolant in the radiator 30 as well as circulates the coolant between the fuel cell 12 and the radiator 30. As a result, the fuel cell 12 is cooled by the coolant and a temperature rise thereof due to the heat generated by the electrochemical reaction is mitigated.

The emission part 44 that emits water to the vehicle front side of (an upper part of) the radiator 30 is disposed in the cooling device 40. The cooling device 40 can cool the radiator 30 using the latent heat of evaporation of water emitted from the emission part 44. Thus, in the cooling device 40, the cooling performance of the radiator 30 can be increased (enhanced) compared with when the coolant is cooled by only an introduced wind (travel wind).

In the cooling device 40, the control unit (not shown) determines whether enhancement of the coolant cooling performance of the radiator 30 is needed. In this case, when the temperature of the fuel cell 12 is maintained within an allowable temperature range, it is determined that enhancement of the coolant cooling performance of the radiator 30 is not needed. On the other hand, for example, when the temperature of the fuel cell 12 becomes closer to an upper limit of the allowable range and reaches a set temperature within the allowable range, it is determined in the cooling device 40 that enhancement of the coolant cooling performance of the radiator 30 is needed.

When it is determined in the cooling device 40 that enhancement of the cooling performance of the radiator 30 is not needed, the operation of the water supply pump 48 is stopped. In the emission part 44, when the operation of the water supply pump 48 is stopped and water supply is stopped, the separator 60 is moved to the closing position on the side of the front wall 54 by the urging force of the coil springs 68 (see FIG. 3A).

In the emission part 44, as the separator 60 is moved by the urging force of the coil springs 68, the leading end portions 70A of the needles 70 mounted on the separator 60 are inserted into the emission holes 58 to close the emission holes 58. Thus, in the cooling device 40, emission of water through the emission holes 58 of the emission part 44 is stopped, and the radiator 30 cools the coolant by only an introduced wind (travel wind).

On the other hand, when it is determined in the cooling device 40 that enhancement of the coolant cooling performance of the radiator 30 is needed, the water supply pump 48 is operated, and the water in the water tank 22 is pumped by the water supply pump 48 and supplied to the front chamber 64 of the emission part 44. In the emission part 44, the water pressure inside the front chamber 64 rises as the water is supplied thereto, and the pressure that pushes the separator 60 increases. Thus, in the emission part 44, the separator 60 is pushed with a pressure larger than the urging force of the coil springs 68, so that the separator 60 is moved to the non-closing position against the urging force of the coil springs 68 (see FIG. 3B).

In the emission part 44, as the separator 60 (and the needles 70) is moved to the non-closing position, the emission holes 58 are opened and the water supplied into the front chamber 64 is emitted toward the radiator core 32 of the radiator 30 through each of the emission holes 58. In the cooling device 40, as the emission holes 58 are opened in the emission part 44, water is emitted through each of the emission holes 58, and the emitted water is guided by an introduced wind to the radiator core 32 and adheres to the radiator core 32.

In the radiator 30, as the water adhering thereto evaporates, cooling of the coolant is promoted by the latent heat of evaporation of the water. As a result, the cooling performance of the radiator 30 is enhanced and a temperature rise of the fuel cell 12 is mitigated.

When the temperature of the fuel cell 12 falls within an allowable range as a result of enhancement of the cooling performance of the radiator 30 etc., and it is determined in the cooling device 40 that enhancement of the coolant cooling performance of the radiator 30 is no longer needed, the operation of the water supply pump 48 is stopped.

In the emission part 44, the water pressure inside the front chamber 64 decreases as water is emitted through the emission holes 58 with the water supply pump 48 stopped and water supply stopped. Thus, in the emission part 44, the separator 60 is moved toward the front wall 54 (moved to the closing position) by the urging force of the coil springs 68, and the needles 70 respectively close the emission holes 58 (see FIG. 3A). In this case, the leading end portions 70A of the needles 70 inserted into the emission holes 58 push out and discharge the water remaining inside the emission holes 58.

In this way, in the cooling device 40, when enhancement of the coolant cooling performance of the radiator 30 is needed, the water supplied to the emission part 44 is emitted toward the radiator 30 (radiator core 32). Thus, the cooling device 40 can enhance the cooling performance of the radiator 30 by the latent heat of evaporation of the water adhering to the radiator 30, and can thereby maintain the temperature of the fuel cell 12 at an allowable temperature.

In the cooling device 40, when emission of water toward the radiator 30 is stopped, the leading end portions 70A of the needles 70 are inserted into the emission holes 58 to push out and discharge the water from inside the emission holes 58. Thus, in the emission part 44, water is prevented from remaining inside the emission holes 58, so that clogging etc. of the emission holes 58 due to the water emitted through the emission holes 58 can be prevented.

Specifically, in the case where the emission part 44 is configured to emit supplied water through the emission holes 58, when water supply to the emission part 44 is stopped and emission of water through the emission holes 58 is stopped, water remains due to surface tension inside the emission holes 58 through which emission of water has been stopped. Floating matter such as grit and dust in the air is likely to adhere to the water remaining in the emission holes 58, and the water remaining in the emission holes 58 is likely to evaporate.

Thus, as the moisture of the water remaining inside the emission holes 58 evaporates, the floating matter adhering to the water, components dissolved in the water, etc. are precipitated as a deposit. When this deposit builds up, it reduces the openings of the emission holes 58 and causes clogging (plugging). In the emission part 44, reduction of the openings of the emission holes 58 or clogging of the emission holes 58 affects emission of water and thereby affects the cooling performance of the radiator 30.

As a countermeasure, the emission part 44 is provided with the needles 70 that are movable to the closing position and the non-closing position of the emission holes 58 and that are moved to the closing position to be inserted into the emission holes 58. Thus, in the emission part 44, precipitation of a deposit inside the emission holes 58 is prevented, and reduction of the openings or clogging of the emission holes 58 due to the water emitted through the emission holes 58 is prevented.

Since the leading end portions 70A of the needles 70 to be inserted into the emission holes 58 have a conical shape, even when a deposit etc. is precipitated inside the emission holes 58, this deposit can be pushed out and removed from the emission holes 58 by the leading end portions 70A. Thus, the likelihood of clogging of the emission holes 58 can be effectively reduced for a long period of time.

Clogging of the emission holes 58 necessitates maintenance of the device for removing the clogging. In the cooling device 40, as clogging of the emission holes 58 of the emission part 44 is prevented, the need for maintenance of the device for removing clogging is eliminated for a long period of time.

In the emission part 44, the emission holes 58 are closed by the needles 70 to keep the water inside the emission part 44 away from air (outside air) around the emission part 44. Thus, even when the temperature around the emission part 44 decreases, the water inside the emission part 44 can be prevented from freezing. Therefore, damage to the emission part 44 or the emission holes 58 due to expansion of water upon freezing can be prevented.

Since the separator 60 is urged by the coil springs 68 in the emission part 44, the water pressure inside the front chamber 64 of the emission part 44 can be made substantially uniform when the water is emitted through the emission holes 58. Thus, even when water is supplied from one end side of the emission part 44 in the longitudinal direction, the water can be emitted through the emission holes 58 at the same pressure. As a result, the water can be caused to adhere evenly to the entire area of the surface of the radiator 30 on the vehicle front side, and the radiator 30 can be effectively cooled using the latent heat of evaporation of the water.

In the embodiment having been described above, the radiator 30 is cooled by the latent heat of evaporation of the water produced in the fuel cell system 10. However, the water is not limited to the water produced in the fuel cell system 10, and water stored in a tank beforehand may instead be used. Further, in the embodiment, the example in which the radiator 30 for cooling the fuel cell 12 of the fuel cell system 10 is cooled by the latent heat of evaporation of water has been described. However, the liquid that cools the heat exchanger by its latent heat of evaporation is not limited to water, and various liquids of which the latent heat of evaporation is available can be adopted.

In the above-described embodiment, the separator 60 that is moved by being urged by the coil springs 68 and can also be moved by water pressure against the urging force of the coil springs 68 is provided inside the emission part 44, and the needles 70 are mounted on the separator 60. However, the moving part may have any configuration that allows it to move the closing member from the non-closing position to the closing position as well as move the closing member from the closing position to the non-closing position when a liquid is supplied to the ejection part.

In the embodiment, the needles 70 of which the leading end portions 70A have a conical shape are used. However, the closing member may have a conical shape as a whole, and can have various shapes as long as the leading end portion can be inserted into the ejection hole by having the same cross-sectional shape as the opening of the ejection hole and the leading end portion can close the ejection hole by being inserted into the ejection hole.

In addition, the heat exchanger cooling device can be used to cool heat exchangers for various objects-to-be-cooled provided in a vehicle such as a storage battery (battery) as an electricity storage part and an electric motor (motor) as a travel power source.

What is claimed is:

1. A heat exchanger cooling device comprising:
a heat exchanger in which a refrigerant for cooling an object-to-be-cooled is cooled by exchanging heat with air introduced into the heat exchanger;
an ejection part that has a hollow inside into which a liquid that cools the heat exchanger by latent heat of evaporation is supplied by a supply part, and that has an ejection hole for ejecting the supplied liquid formed in a surface facing the heat exchanger so as to extend through the surface;
a closing member that is movable between a closing position in which the closing member is inserted into the ejection hole to close the ejection hole, and a non-closing position in which the closing member has receded from the ejection hole to allow the liquid to be ejected through the ejection hole; and
a moving part that moves the closing member to the non-closing position when the liquid is supplied to the ejection part, and moves the closing member to the closing position when supply of the liquid to the ejection part is stopped.
